(19) United States
(12) Patent Application Publication
(10) Pub. No.: US 2024/0413465 A1
(43) Pub. Date: Dec. 12, 2024

(54) BATTERY ASSEMBLY JOINT

(71) Applicant: Rivian IP Holdings, LLC, Irvine, CA (US)

(72) Inventors: Akshay Kishor Murkute, Irvine, CA (US); Kyle Butterfield, Ladera Ranch, CA (US); Brandon Thayer, Mission Viejo, CA (US); Ryan Arens, Irvine, CA (US); Andrew Richard Campbell, Aliso Viejo, CA (US)

(21) Appl. No.: 18/332,539

(22) Filed: Jun. 9, 2023

(51) Int. Cl. H01M 50/264; H01M 50/227; H01M 50/249

(52) U.S. Cl. CPC H01M 50/264; H01M 50/227; H01M 50/249; H01M 2220/20

(57) ABSTRACT

A system can include a battery subassembly having a flange. The flange can engage a first cross member and a second cross member of a battery pack using a fastener to clamp the battery subassembly with the first cross member and the second cross member.

### INTRODUCTION

Electric vehicles can include various electrical components that provide power to the vehicle. The electrical components can be electrically coupled with vehicle components to power the vehicle.

### SUMMARY

A clamped joint of a battery pack can include a plurality of fasteners that each extend at least partially through a first cross member of a battery pack, a first flange of a battery subassembly, a flange of a thermal component of the battery subassembly, a second flange of the battery subassembly, and a second cross member of the battery pack to clamp the first cross member, the first flange of the battery subassembly, the flange of the thermal component, the second flange of the battery subassembly, and the second cross member of the battery pack together in a stack. The clamped joint, or one or more components of the clamped joint, can include one or more features to facilitate absorbing a compression load of the clamped joint. The clamped joint allows for robust manufacturing and a distribution of a compression load throughout at least a portion of the clamped joint (e.g., as opposed to a point load applied at one specific location of the clamped joint). Having a line load distributed over a width of the clamped joint (e.g., at or between the fasteners) as opposed to a point load at a specific location of the joint can facilitate reducing fatigue, stress, strain, or creep on the clamped joint, allowing the joint to maintain structure for longer periods of time.

At least one aspect is directed to a system. The system can include a battery subassembly having a flange. The flange can engage a first cross member and a second cross member of a battery pack using a fastener to clamp the battery subassembly with the first cross member and the second cross member.

At least one aspect is directed to an electric vehicle. The electric vehicle can include a battery subassembly having a flange. The flange can engage a first cross member and a second cross member of a battery pack using a fastener to clamp the battery subassembly with the first cross member and the second cross member.

At least one aspect is directed to a method. The method can include providing a battery subassembly having a flange. The method can include engaging, by the flange, a first cross member and a second cross member of a battery pack using a fastener to clamp the battery subassembly with the first cross member and the second cross member.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example side view of an electric vehicle, in accordance with implementations.

FIG. 2A depicts an example perspective view of a battery pack, in accordance with implementations.

FIG. 2B depicts an example perspective view of a plurality of battery subassemblies of the battery pack of FIG. 2A, in accordance with implementations.

FIG. 2C depicts a cross sectional view of a battery cell, in accordance with implementations.

FIG. 2D depicts a cross sectional view of a battery cell, in accordance with implementations.

FIG. 2E depicts a cross sectional view of a battery cell, in accordance with implementations.

FIG. 2F depicts an example flowchart of a method of forming a battery subassembly, in accordance with implementations.

FIG. 2G depicts an example cross-section of a battery pack, in accordance with implementations.

FIG. 3A depicts an example perspective view of a battery subassembly of the battery pack of FIG. 2A, in accordance with implementations.

FIG. 3B depicts an example front sectional view of a system having the battery subassembly in FIG. 3A, in accordance with implementations.

FIG. 4 depicts an example detailed view of a portion of the system of FIG. 3B, in accordance with implementations.

FIG. 5A depicts an example front sectional view of the system of FIG. 3B, in accordance with implementations.

FIG. 5B depicts an example schematic of the system of FIG. 3B, in accordance with implementations.

FIG. 5C depicts an example perspective view of a portion of the system of FIG. 3B, in accordance with implementations.

FIG. 6A depicts an example front sectional view of the system of FIG. 3B, in accordance with implementations.

FIG. 6B depicts an example schematic of the system of FIG. 3B, in accordance with implementations.

FIG. 6C depicts an example perspective view of a portion of the system of FIG. 3B, in accordance with implementations.

FIG. 6D depicts an example front sectional view of the system of FIG. 3B, in accordance with implementations.

FIG. 6E depicts an example perspective view of a portion of the system of FIG. 3B, in accordance with implementations.

FIG. 7A depicts an example front sectional view of the system of FIG. 3B, in accordance with implementations.

FIG. 7B depicts an example schematic of the system of FIG. 3B, in accordance with implementations.

FIG. 7C depicts an example side view of a portion of the system of FIG. 3B, in accordance with implementations.

FIG. 8A depicts an example front sectional view of the system of FIG. 3B, in accordance with implementations.

FIG. 8B depicts an example schematic of the system of FIG. 3B, in accordance with implementations.

FIG. 9 depicts an example top view of a portion of the system of FIG. 3B, in accordance with implementations.

FIG. 10 depicts an example bottom view of a portion of the system of FIG. 3B in a first state, in accordance with implementations.

FIG. 11 depicts an example view of a portion of the system of FIG. 3B in a second state, in accordance with implementations.

FIG. 12 depicts an example view of a portion of the system of FIG. 3B in a first state, in accordance with implementations.

FIG. 13 depicts an example view of a portion of the system of FIG. 3B in a second state, in accordance with implementations.

FIG. 14 depicts an example illustration of a process, in accordance with implementations.

FIG. 15 depicts an example illustration of a process, in accordance with implementations.

### DETAILED DESCRIPTION

Following below are more detailed descriptions of various concepts related to, and implementations of, methods, apparatuses, and systems of a clamped joint of one or more battery subassemblies (e.g., components holding one or more battery cells) within a vehicle. The clamped joint can include a plurality of fasteners that each extend at least partially through a first cross member of a battery pack, a first flange of the battery subassembly, a flange of a thermal component of the battery subassembly, a second flange of the battery subassembly, and a second cross member of the battery pack. The fasteners can clamp the first cross member, the first flange of the battery subassembly, the flange of the thermal component, the second flange of the battery subassembly, and the second cross member of the battery pack together in a stack to fix the battery subassembly with the first cross member and the second cross member. The clamped joint can include a second battery subassembly. For example, the fasteners can additionally extend through at least partially though a first flange of a second battery subassembly, a flange of a second thermal component of the second battery subassembly, and a second flange of the second battery subassembly to fix the two battery subassemblies together and with the first cross member and the second cross member. The clamped joint, or one or more components of the clamped joint, can include one or more features to facilitate absorbing a compression load between the clamped joint.

The disclosed solutions have a technical advantage of robust manufacturing and a distribution of a compression load throughout at least a portion of the clamped joint (e.g., as opposed to a point load applied at one specific location of the clamped joint). Having a line load distributed over a width of the clamped joint as opposed to a point load at a specific location of the joint can facilitate reducing fatigue, stress, strain, or creep on the clamped joint, allowing the joint to maintain structure for longer periods of time.

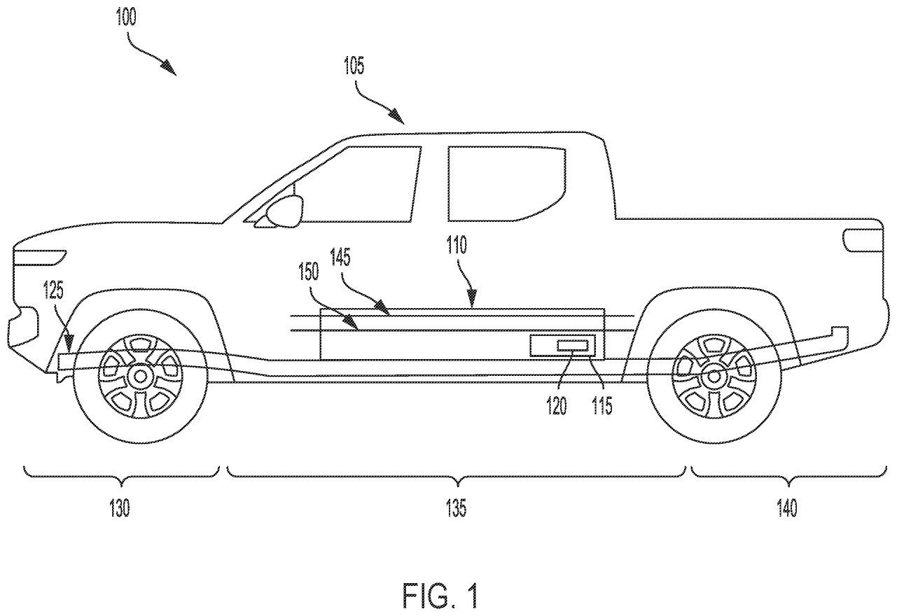

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery subassemblies 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery subassemblies 115, or the battery cells 120 with other electrical components of the electric vehicle 105 to provide electrical power to various systems or components of the electric vehicle 105.

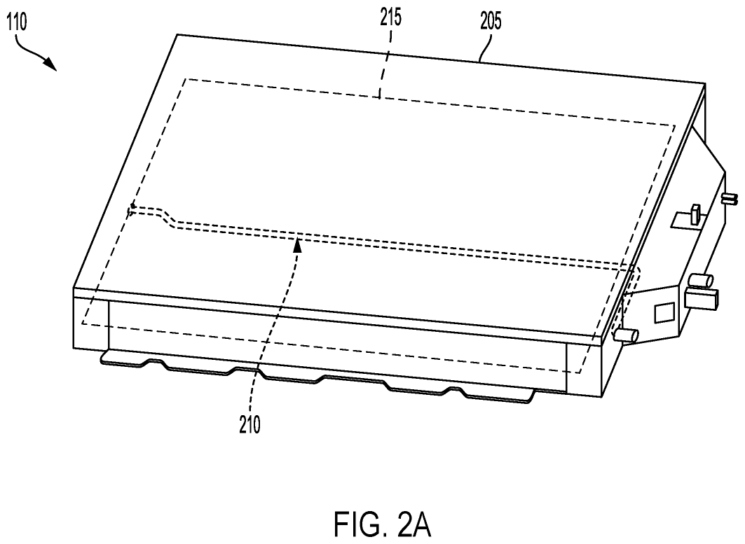

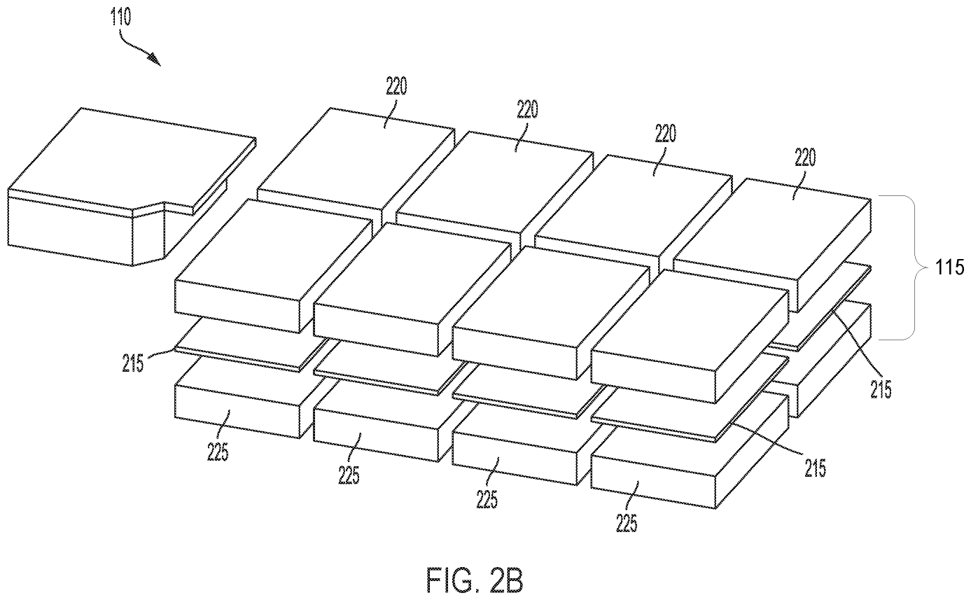

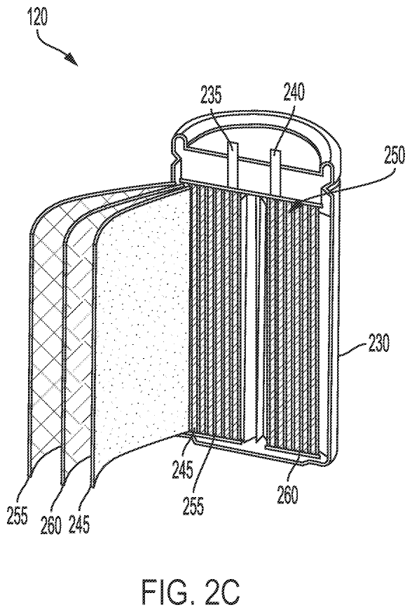

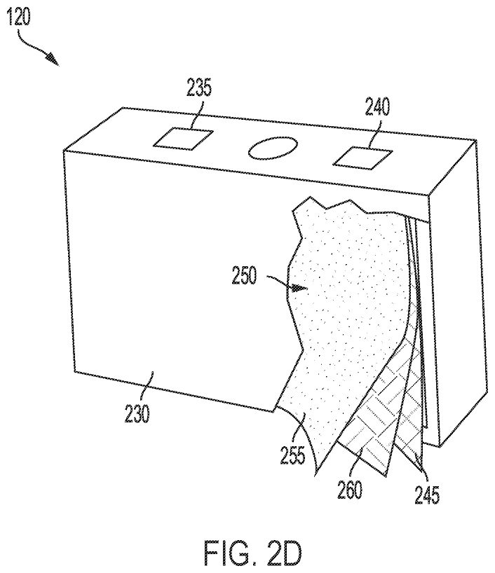

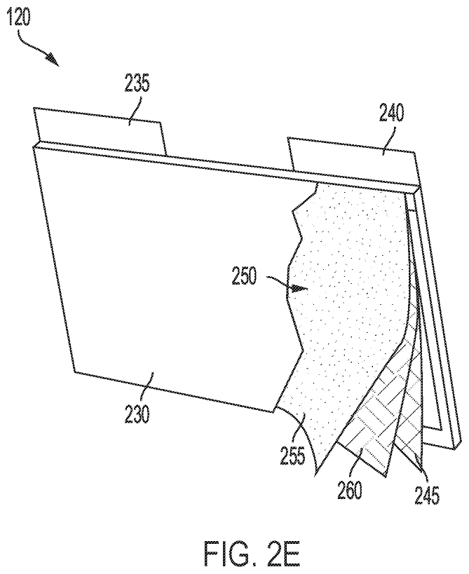

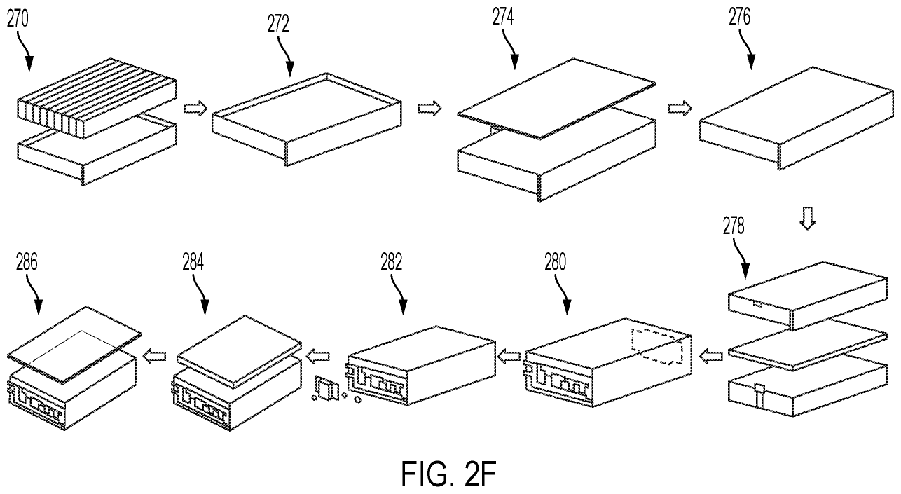

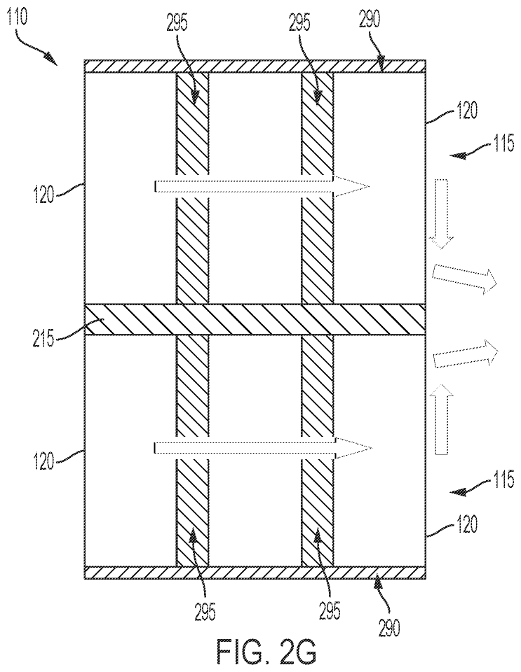

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery subassembly 115 or at least one battery cell 120, as well as other battery pack components. The battery subassembly 115 can be or can include one or more groups of prismatic cells, cylindrical cells, pouch cells, or other form factors of battery cells 120. For example, the battery subassembly 115 can be or include one or more battery cell carriers, thermal components 215, modules, or other components that form a joining of a plurality of battery cells 120 together. The housing 205 can include a shield on the bottom or underneath the battery subassembly 115 to protect the battery subassembly 115 and/or cells 120 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, among other possibilities. The battery pack 110 can include any number of thermal components 215. For example, there can be one or more thermal components 215 per battery pack 110, or per battery subassembly 115. At least one cooling line 210 can be coupled with, part of, or independent from the thermal component 215.

FIG. 2B depict a plurality of example battery subassemblies 115, and FIGS. 2C, 2D and 2E depict an example cross sectional view of a battery cell 120. The battery subassemblies 115 can include at least one submodule. For example, the battery subassemblies 115 can include at least one first (e.g., top) submodule 220 or at least one second (e.g., bottom) submodule 225. At least one thermal component 215 can be disposed between the top submodule 220 and the bottom submodule 225. For example, one thermal component 215 can be configured for heat exchange with one battery subassembly 115. The thermal component 215 can be disposed or thermally coupled between the top submodule 220 and the bottom submodule 225. One thermal component 215 can also be thermally coupled with more than one battery subassembly 115 (or more than two submodules 220, 225). The thermal components 215 shown adjacent to each other can be combined into a single thermal component 215 that spans the size of one or more submodules 220 or 225. The thermal component 215 can be positioned underneath submodule 220 and over submodule 225, in between submodules 220 and 225, on one or more sides of submodules 220, 225, among other possibilities. The thermal component 215 can be disposed in sidewalls, cross members, structural beams, among various other components of the battery pack, such as battery pack 110 described above. The battery submodules 220, 225 can collectively form one battery subassembly 115. In some examples each submodule 220, 225 can be considered as a complete battery subassembly 115, rather than a submodule.

The battery subassemblies 115 can each include a plurality of battery cells 120. The battery subassemblies 115 can be disposed within the housing 205 of the battery pack 110. The battery subassemblies 115 can include battery cells 120 that are cylindrical cells or prismatic cells, for example. The battery subassembly 115 can operate as a modular unit of battery cells 120. For example, a battery subassembly 115 can collect current or electrical power from the battery cells 120 that are included in the battery subassembly 115 and can provide the current or electrical power as output from the battery pack 110. The battery pack 110 can include any number of battery subassemblies 115. For example, the battery pack can have one, two, three, four, five, six, seven, eight, nine, ten, eleven, twelve or other number of battery subassemblies 115 disposed in the housing 205. It should also be noted that each battery subassembly 115 may include a top submodule 220 and a bottom submodule 225, possibly with a thermal component 215 in between the top submodule 220 and the bottom submodule 225. The battery pack 110 can include or define a plurality of areas for positioning of the battery subassembly 115 and/or cells 120. The battery subassemblies 115 can be square, rectangular, circular, triangular, symmetrical, or asymmetrical. In some examples, battery subassemblies 115 may be different shapes, such that some battery subassemblies 115 are rectangular but other battery subassemblies 115 are square shaped, among other possibilities. The battery subassembly 115 can include or define a plurality of slots, holders, or containers for a plurality of battery cells 120. It should be noted the illustrations and descriptions herein are provided for example purposes and should not be interpreted as limiting. For example, the battery cells 120 can be inserted in the battery pack 110 without battery modules 220 and 225. The battery cells 120 can be disposed in the battery pack 110 in a cell-to-pack configuration without modules 220 and 225, among other possibilities.

Battery cells 120 have a variety of form factors, shapes, or sizes. For example, battery cells 120 can have a cylindrical, rectangular, square, cubic, flat, pouch, elongated or prismatic form factor. As depicted in FIG. 2C, for example, the battery cell 120 can be cylindrical. As depicted in FIG. 2D, for example, the battery cell 120 can be prismatic. As depicted in FIG. 2E, for example, the battery cell 120 can include a pouch form factor. Battery cells 120 can be assembled, for example, by inserting a winded or stacked electrode roll (e.g., a jelly roll) including electrolyte material into at least one battery cell housing 230. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 120 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 120. The housing 230 can be of various shapes, including cylindrical or rectangular, for example. Electrical connections can be made between the electrolyte material and components of the battery cell 120. For example, electrical connections to the electrodes with at least some of the electrolyte material can be formed at two points or areas of the battery cell 120, for example to form a first polarity terminal 235 (e.g., a positive or anode terminal) and a second polarity terminal 240 (e.g., a negative or cathode terminal). The polarity terminals can be made from electrically conductive materials to carry electrical current from the battery cell 120 to an electrical load, such as a component or system of the electric vehicle 105.

For example, the battery cell 120 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. It should be noted that battery cell 120 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂ (XO₄)₃ (A=Ca, Sr, Ba and X=Nb. Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X=Cl. Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 120 can be included in battery subassemblies 115 or battery packs 110 to power components of the electric vehicle 105. The battery cell housing 230 can be disposed in the battery subassembly 115, the battery pack 110, or a battery array installed in the electric vehicle 105. The housing 230 can be of any shape, such as cylindrical with a circular (e.g., as depicted in FIG. 2C, among others), elliptical, or ovular base, among others. The shape of the housing 230 can also be prismatic with a polygonal base, as shown in FIG. 2D, among others. As shown in FIG. 2E, among others, the housing 230 can include a pouch form factor. The housing 230 can include other form factors, such as a triangle, a square, a rectangle, a pentagon, and a hexagon, among others. In some embodiments, the battery subassembly may include or be provided as a battery module. In other embodiments, the battery pack may not include modules (e.g., module-free). For example, the battery pack can have a module-free or cell-to-pack configuration where the battery cells are arranged directly into a battery pack without assembly into a module.

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 230 of the battery cell 120 is prismatic (e.g., as depicted in FIG. 2D, among others) or cylindrical (e.g., as depicted in FIG. 2C, among others), the housing 230 can include a rigid or semi-rigid material such that the housing 230 is rigid or semi-rigid (e.g., not easily deformed or manipulated into another shape or form factor). In examples where the housing 230 includes a pouch form factor (e.g., as depicted in FIG. 2E, among others), the housing 230 can include a flexible, malleable, or non-rigid material such that the housing 230 can be bent, deformed, manipulated into another form factor or shape.

The battery cell 120 can include at least one anode layer 245, which can be disposed within the cavity 250 defined by the housing 230. The anode layer 245 can include a first redox potential. The anode layer 245 can receive electrical current into the battery cell 120 and output electrons during the operation of the battery cell 120 (e.g., charging or discharging of the battery cell 120). The anode layer 245 can include an active substance. The active substance can include, for example, an activated carbon or a material infused with conductive materials (e.g., artificial or natural graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp² hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 120 can include at least one cathode layer 255 (e.g., a composite cathode layer compound cathode layer, a compound cathode, a composite cathode, or a cathode). The cathode layer 255 can include a second redox potential that can be different than the first redox potential of the anode layer 245. The cathode layer 255 can be disposed within the cavity 250. The cathode layer 255 can output electrical current out from the battery cell 120 and can receive electrons during the discharging of the battery cell 120. The cathode layer 255 can also receive lithium ions during the discharging of the battery cell 120. Conversely, the cathode layer 255 can receive electrical current into the battery cell 120 and can output electrons during the charging of the battery cell 120. The cathode layer 255 can release lithium ions during the charging of the battery cell 120.

The battery cell 120 can include a layer 260 disposed within the cavity 250. The layer 260 can include a solid electrolyte layer. The layer 260 can include a separator wetted by a liquid electrolyte. The layer 260 can include a polymeric material. The layer 260 can include a polymer separator. The layer 260 can be arranged between the anode layer 245 and the cathode layer 255 to separate the anode layer 245 and the cathode layer 255. The polymer separator can physically separate the anode and cathode from a cell short circuit. A separator can be wetted with a liquid electrolyte. The liquid electrolyte can be diffused into the anode layer 245. The liquid electrolyte can be diffused into the cathode layer 255. The layer 260 can help transfer ions (e.g., Li⁺ ions) between the anode layer 245 and the cathode layer 255. The layer 260 can transfer Li⁺ cations from the anode layer 245 to the cathode layer 255 during the discharge operation of the battery cell 120. The layer 260 can transfer lithium ions from the cathode layer 255 to the anode layer 245 during the charge operation of the battery cell 120.

The redox potential of layers (e.g., the first redox potential of the anode layer 245 or the second redox potential of the cathode layer 255) can vary based on a chemistry of the respective layer or a chemistry of the battery cell 120. For example, lithium-ion batteries can include an LFP (lithium iron phosphate) chemistry, an LMFP (lithium manganese iron phosphate) chemistry, an NMC (Nickel Manganese Cobalt) chemistry, an NCA (Nickel Cobalt Aluminum) chemistry, an OLO (Over Lithiated Oxide) chemistry, or an LCO (lithium cobalt oxide) chemistry for a cathode layer (e.g., the cathode layer 255). Lithium-ion batteries can include a graphite chemistry, a silicon-graphite chemistry, or a lithium metal chemistry for the anode layer (e.g., the anode layer 245).

For example, lithium-ion batteries can include an olivine phosphate (LiMPO₄, M=Fe and/or Co and/or Mn and/or Ni)) chemistry, LISICON or NASICON Phosphates (Li₃M₂(PO₄)₃ and LIMPO₄Oₓ, M=Ti, V, Mn, Cr, and Zr), for example lithium iron phosphate (LFP), lithium iron manganese phosphate (LMFP), layered oxides (LiMO₂, M=Ni and/or Co and/or Mn and/or Fe and/or Al and/or Mg) examples, NMC (Nickel Manganese Cobalt) chemistry, an NCA (Nickel Cobalt Aluminum) chemistry, or an LCO (lithium cobalt oxide) chemistry for a cathode layer, lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fe, Co, Ni) and Fluorosulfates LiMSO₄F (M=Co, Ni, Mn) (e.g., the cathode layer 255). Lithium-ion batteries can include a graphite chemistry, a silicon-graphite chemistry, or a lithium metal chemistry for the anode layer (e.g., the anode layer 245). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, or other additives as a coating on a current collector (metal foil). The chemical composition of the electrode layers can affect the redox potential of the electrode layers. For example, cathode layers (e.g., the cathode layer 255) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and lithium iron manganese phosphate (“LMFP”). Anode layers (e.g., the anode layer 245) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, cascine, chitosan, cyclodextrines (carbonyl-beta), ethylene propylene diene monomer (EPDM) rubber, gelatine, gellan gum, guar gum, karaya gum, cellulose (natural), pectine, poly (3,4-ethylenedioxythiophene) polystyrene sulfonate (PEDOT-PSS), polyacrylic acid (PAA), poly (methyl acrylate) (PMA), poly (vinyl alcohol) (PVA), poly (vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The layer 260 can include or be made of a liquid electrolyte material. For example, the layer 260 can be or include at least one layer of polymeric material (e.g., polypropylene, polyethylene, or other material) including pores that are wetted (e.g., saturated with, soaked with, receive, are filled with) a liquid electrolyte substance to enable ions to move between electrodes. The liquid electrolyte material can include a lithium salt dissolved in a solvent. The lithium salt for the liquid electrolyte material for the layer 260 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. Liquid electrolyte is not necessarily disposed near the layer 260, but the liquid electrolyte can fill the battery cells 120 in many different ways. The layer 260 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂ (XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₇S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the layer 260 includes a liquid electrolyte material, the layer 260 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The layer 260 can include at least one additive. The additives can be or include vinylidene carbonate, fluoroethylene carbonate, ethyl propionate, methyl propionate, methyl acetate, ethyl acetate, or a mixture of any two or more thereof. The layer 260 can include a lithium salt material. For example, the lithium salt can be lithium perchlorate, lithium hexafluorophosphate, lithium bis (fluorosulfonyl) imide, lithium bis (trifluorosulfonyl) imide, or a mixture of any two or more thereof. The lithium salt may be present in the layer 260 from greater than 0 M to about 1.5 M. Once disposed to the battery cell 120, liquid electrolyte can be present and touching battery subcomponents present within the battery cell 120. The battery subcomponents can include the cathode, the anode, the separator, the current collector, etc.

FIG. 2F depicts an example flowchart of a process of forming a battery subassembly 115. At step 270, at least one battery cell 120 is loaded into a cell carrier (described herein). At step 272, an adhesive (e.g., wicking adhesive) is applied to the battery cells 120 or carrier to facilitate fixing the battery cells 120 to the carrier. At step 274, a current collector assembly (CCA) is coupled with the battery cells 120. At step 276, the CCA is welded to at least one cell terminal (e.g., button). At step 278, a first cell carrier, a thermal component 215, and a second cell carrier are coupled together to form a subassembly. At step 280, terminal busbars and series busbars are coupled with the subassembly. At step 282, various components such as fuses, switches, current sensors, temperature sensors, voltage sensors, thermistors, contactors, and/or the like can be coupled with the subassembly. For example, a thermistor harness and/or a battery voltage temperature monitor (BVT) configured to receive electrical signals, data packets, measurements, sensor readings, or other data to indicate characteristics of the battery subassembly such as temperature, voltage, state of charge and/or fault status for communication to a battery management system (BMS) can be coupled to the subassembly. At step 284, potting occurs (e.g., partially or completely filling a space between the batteries with a compound to provide resistance to shock waves or vibrations) subsequent the first carrier is coupled with the second carrier with the thermal component 215 disposed in between the carriers. At step 286, a touch cover can be coupled with the subassembly. The process of forming the subassembly, as shown and described herein in which the thermal component 215 is the central unit and can act as a central datumning component thereby eliminating shear walls and external datums and/or facilitate a more stable and efficient manufacturing process.

As depicted in FIG. 2G, among others, the battery subassembly 115 can include a plurality of battery cells 120 and at least one current collector 290. The current collector 290 can include an electrically conductive member that can electrically couple multiple battery cells 120 with each other. For example, the current collector 290 can electrically couple multiple battery cells 120 together in a series configuration, a parallel configuration, or some other configuration, such as by physically contacting one or more terminals of the multiple battery cells 120. The battery pack 110 can include one current collector 290 for each battery subassembly 115. For example, as depicted in FIG. 2G, among others, each subassembly 115 can include multiple battery cells 120 and one current collector 290 to electrically couple the battery cells 120 together.

The battery cells 120 can be positioned adjacent to one another such that at least a portion of battery cells 120 are in contact (e.g., touching, abutting) with at least one adjacent battery cell 120. The battery cells 120 can be positioned such that at least a portion of a battery cell 120 are not in contact with an adjacent battery cell 120. For example, as depicted in FIG. 2G, due to the arrangement, configuration, and shapes of the battery cells, the battery cells 120 can be positioned relative to at least one adjacent battery cell 120 with an interstitial area 295 positioned between the adjacent battery cells 120. The interstitial area 295 can include a space, gap, opening, or cavity positioned between adjacent battery cells 120. The battery cells 120 can be completely or partially enveloped by the interstitial area 295 in a radial direction. For example, if a battery cell 120 is not contacting any adjacent battery cell 120, the interstitial area 295 can surround a radial surface of the battery cell 120 in a radial direction (e.g., excluding a top and bottom, which can be coupled with the current collector 290 or a thermal component 215, for example). In the examples in which a portion of the battery cell 120 contacts at least one adjacent battery cell 120, the interstitial area 295 can partially surround the battery cell 120. For example, multiple discrete (e.g., separated, individual) interstitial areas 295 can exist within the subassembly 115, with each interstitial area 295 separated from other interstitial areas 295 because of at least two battery cells abutting (e.g., contacting, touching) each other. The interstitial area 295 can exist as a product of a shape, arrangement, and configuration of the battery cells 120. For example, the battery cells 120 can be cylindrical in form such that a group of multiple (e.g., three, four, or some other number) of neighboring battery cells 120 can only contact each other along a line or an edge, rather than a surface (as may be the case with prismatic battery cells 120, for example). At least a portion of the interstitial area 295 (e.g., 80-100%) can be filled with potting and at least a portion of an area between a battery cell 120 and the thermal component 215 can be filled with a thermal adhesive. As depicted in the arrows in FIG. 2G, this configuration of the battery pack 110 allows for a load path to extend across an approximate midpoint of the battery cells 120 along a wall of the carriers described herein, and through flanges of the carriers described herein.

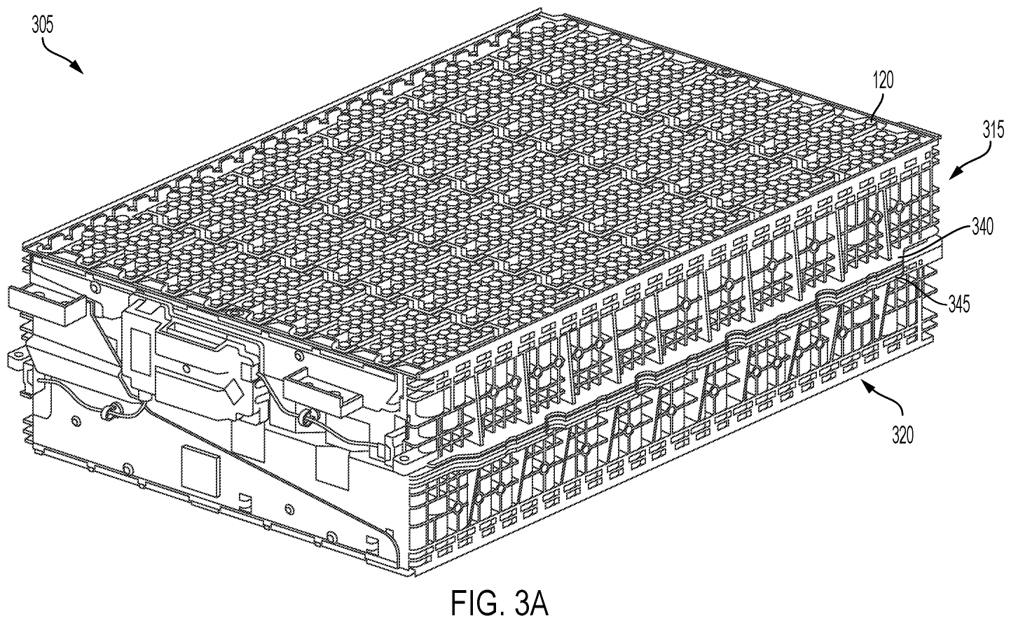

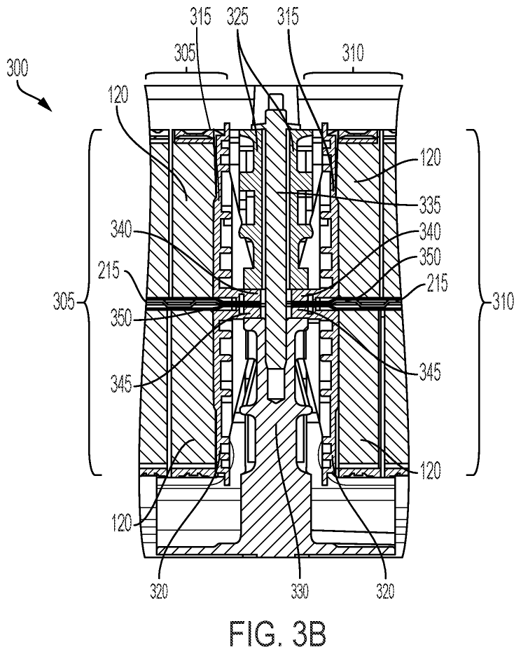

FIG. 3A depicts an example perspective view of a first battery subassembly 305 and FIG. 3B depicts an example front sectional view of a system 300 having the first battery subassembly 305. The first battery subassembly 305 can include various components to facilitate storing at least one battery cell 120 within a vehicle 105. For example, the first battery subassembly 305 can include a similar configuration as the battery subassemblies 115 described herein. For example, the first battery subassembly 305 can include a first cell carrier 315, a second cell carrier 320, and a thermal component 215 (depicted in at least FIG. 3B). The first cell carrier 315 can include one or more components to hold or carry at least one battery cell 120 in position. For example, the first cell carrier 315 can include one or more pockets (e.g., battery cell-shaped holes, clamps, or other components that can receive a battery cell 120 to couple the battery cell 120 with the first carrier 315. The second cell carrier 320 can include a similar configuration and size as the first cell carrier 315. For example, the second cell carrier 320 can include at least one pocket to receive at least one battery cell 120. The thermal component 215 can be positioned at a middle portion of the first battery subassembly 305 between the first cell carrier 315 and the second cell carrier 320.

The system 300 can be or can include a clamped joint of one or more battery subassemblies (e.g., battery subassemblies 115 or carriers for battery cells 120). For example, the system 300 can include the first battery subassembly 305 and a second battery subassembly 310 (e.g., as depicted in at least FIG. 3B). The second battery subassembly 310 can include one or more similar components as the first battery subassembly 305. For example, the second battery subassembly 310 can include at least one battery cell 120. The second battery subassembly 310 can include a first cell carrier 315, a second cell carrier 320, and a thermal component 215. The first cell carrier 315 can include one or more components to hold or carry at least one battery cell 120 in position. For example, the first cell carrier 315 can include one or more pockets (e.g., battery cell-shaped holes, clamps, or other components that can receive a battery cell 120 to couple the battery cell 120 with the first carrier 315. The second cell carrier 320 can include a similar configuration and size as the first cell carrier 315. For example, the second cell carrier 320 can include at least one pocket to receive at least one battery cell 120. The thermal component 215 can be positioned at a middle portion of the first battery submodule 305 between the first cell carrier 315 and the second cell carrier 320.

The system 300 can include one or more components that can couple the first battery subassembly 305 with the second battery subassembly 310. For example, the system 300 can include one or more components that facilitate coupling the first battery subassembly 305 or the second battery subassembly 310 with one or more portions of a vehicle 105 (e.g., such that the battery cells 120 of the battery subassemblies 305, 310 are fixed with the vehicle 105). The system 300 can include, for example, a first cross member 325 and a second cross member 330. The first cross member 325 can substantially oppose the second cross member 330 (e.g., such that the first cross member 325 is positioned on top of the second cross member 330). The first cross member 325 and the second cross member 330 can include beams that extend throughout a battery pack 110 of the vehicle 105 (e.g., about the same distance as a first flange 340 or a second flange 345 described herein and depicted in at least FIG. 3A). The system 300 can include one or more fasteners 335 (e.g., such as a plurality of fasteners 335) that can at least partially extend through one or more of the first cross member 325, the first or second carriers 315, 320 of the subassemblies 305, 310, the thermal components 215 of the subassemblies 305, 310, or the second cross member 330 to clamp each of the components together and form a clamped joint. For example, the at least one fastener 335 can clamp or bias at least the first cross member 325 and the second cross member 330 together. The first cross member 325 and the second cross member 330 can apply and distribute a clamp load to the first flange 340, the second flange 345, and the thermal component flange 350, as partially depicted by the arrows in FIG. 2G (the flanges 340, 345, 350 not depicted). The first cross member 325 or the second cross member 330 can couple with a portion of the vehicle 105 (e.g., with a portion of a battery pack 110) to mount the system 300 to the vehicle 105.

One or more of the battery cell carriers 315, 320 and one or more thermal components 215 can include a flange that can be clamped between the first cross member 325 and the second cross member 330. For example, the first cell carrier 315 (e.g., of the first battery subassembly 305 or the second battery subassembly 310) can include a first carrier flange 340 and the second cell carrier 320 (e.g., of the first battery subassembly 305 or the second battery subassembly 310) can include a second carrier flange 345. Each of the first carrier flange 340 and the second carrier flange 345 can extend or protrude substantially sideways from the respective cell carriers (e.g., such that the first carrier flange 340 defines the outermost portion of the first cell carrier 315 and the second carrier flange 345 defines the outermost portion of the second cell carrier 320). The thermal component 215 (e.g., of first battery subassembly 305 or the second battery subassembly 310) can include a thermal component flange 350. The thermal component flange 350 can be disposed between and in at least partial contact with the first carrier flange 340 and the second carrier flange 345. The thermal component flange 350 can extend or protrude substantially sideways from the thermal component 215 (e.g., such that the thermal component flange 350 defines the outermost portion of the thermal component 215).

Each of the first carrier flange 340, the thermal component flange 350, and the second carrier flange 345 can be stacked together in an outwardly protruding manner such that the first cross member 325 and the second cross member 330 can clamp the first carrier flange 340, the thermal component flange 350, and the second carrier flange 345 together by the fastener 335 to fix the first subassembly 305 or the second subassembly 310 together or with the vehicle 105. For example, at least one flange (e.g., one or more of the first flange 340, the second flange 345, or the thermal component flange 350) can engage (e.g., at least partially contact, couple with, apply a load to, experience a load from, etc.) with the first cross member 325 and the second cross member 330 using the fastener 335 to clamp the first battery subassembly 305 with the first cross member 325 and the second cross member 330. For example, the fastener 335 at least partially extending through the first cross member 325 (e.g., through an opening in the first cross member 325), the first carrier flanges 340 (e.g., through a divot in the flange 340), the thermal component flanges 350 (e.g., through a divot in the flange 350), the second carrier flanges 345 (e.g., through a divot in the flange 345), or the second cross member 330 (e.g., through an opening in the second cross member 330) can form a clamped joint to fix the first battery subassembly 305 or the second battery subassembly 310 in place relative to the battery pack 110 or the vehicle 105. The system 300 can facilitate substantially evenly distributing a compression load of the joint (e.g., by the one or more fasteners 335) throughout a portion of the joint to form a line load displacement as opposed to a point load.

The system 300 can extend at least partially throughout the battery pack 110 of the vehicle 105 such that the system 300 can include a plurality of fasteners 335 that can extend through a plurality of apertures, holes, or divots formed in the first carrier flange 340, the thermal component flange 350, the second carrier flange 345, and the first and second cross members. For example, the system 300 can include five fasteners 335 to fix each battery subassembly 305, 310 or each set of battery subassemblies 305, 310 (e.g., five fasteners 335 for both of the first battery subassembly 305 and the second battery subassembly 310). The system 300 can include more or less fasteners 335 and respective holes, apertures, or divots (e.g., one fastener 335, two fasteners 335, three fasteners 335, four fasteners 335, or more than five fasteners 335).

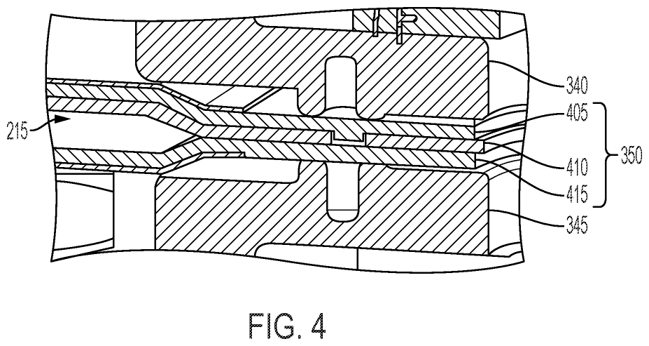

FIG. 4 depicts a perspective sectional view of a portion of the system 300. For example, FIG. 4 depicts a close-up view of a first carrier flange 340, a thermal component flange 350, and a second carrier flange 345 (e.g., of the first subassembly 305) clamped together. The thermal component 215 can include one or more portions making up the thermal component 215. For example, the thermal component 215 can include a first thermal component portion 405, a second thermal component portion 410, and a third thermal component portion 415. As depicted in at least FIGS. 3A and 4, the thermal component flange 350 can include the first thermal component portion 405, the second thermal component portion 410, and the third thermal component portion 415 stacked together to form the flange 350. The first thermal component portion 405 and the third thermal component portion 415 can branch out in opposing directions in a direction moving away from the thermal component flange 350. The second thermal component portion 410 can extend in a serpentine (e.g., “S”-shaped) manner such that, at a first section of the thermal component 215, at least a portion of the second thermal component portion 410 is in direct contact with the first thermal component portion 405 but is not in direct contact with the third thermal component portion 415 (e.g., such that a space is defined between the second thermal component portion 410 and the third thermal component portion 415) and, at a second section of the thermal component 215, at least a portion of the second thermal component portion 410 is in direct contact with the third thermal component portion 415 but is not in direct contact with the first thermal component portion 405 (e.g., such that a space is defined between the second thermal component portion 410 and the first thermal component portion 405).

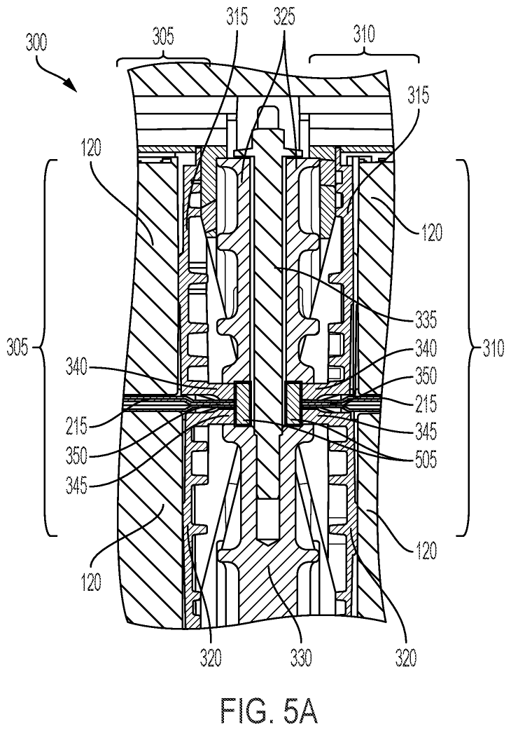

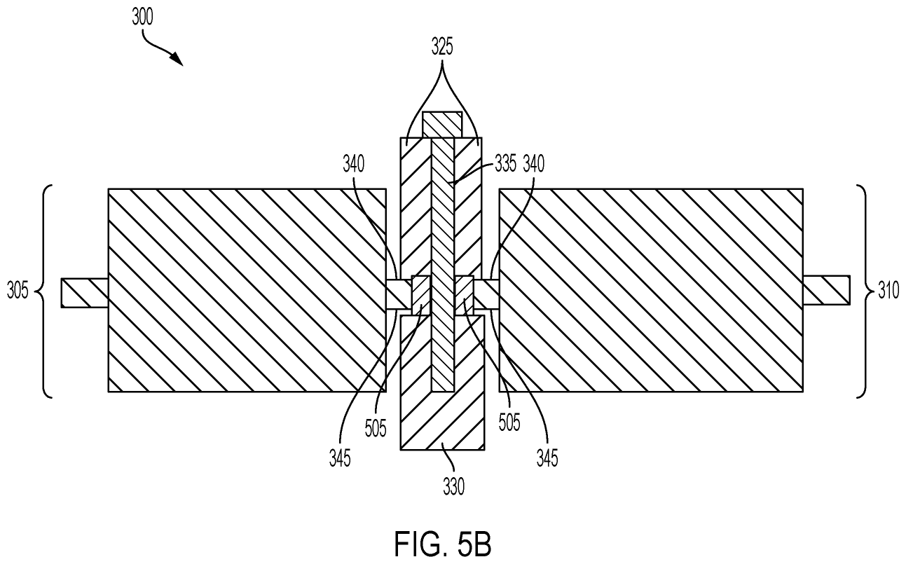

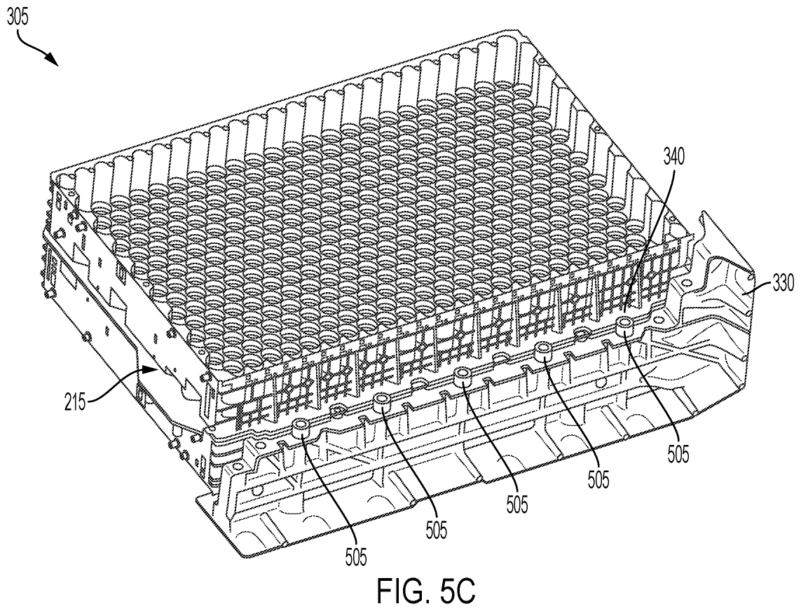

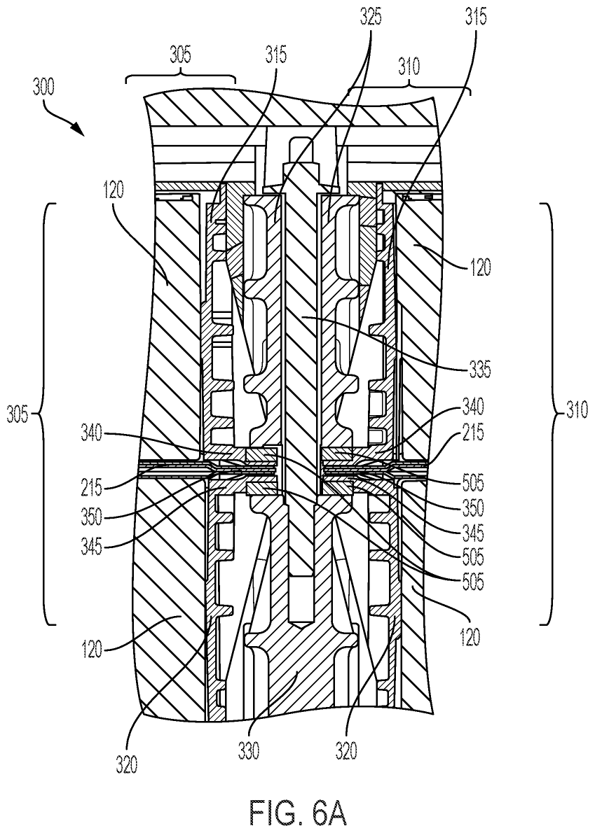

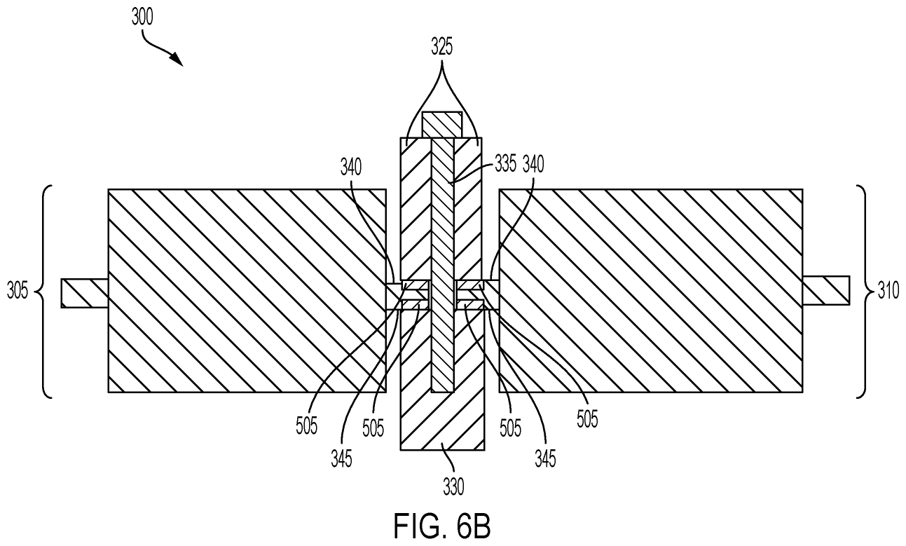

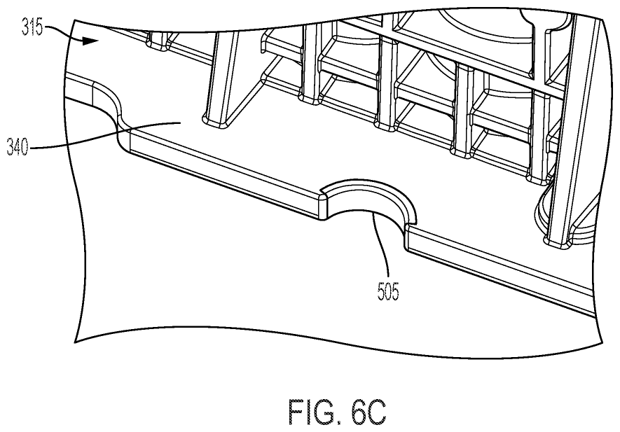

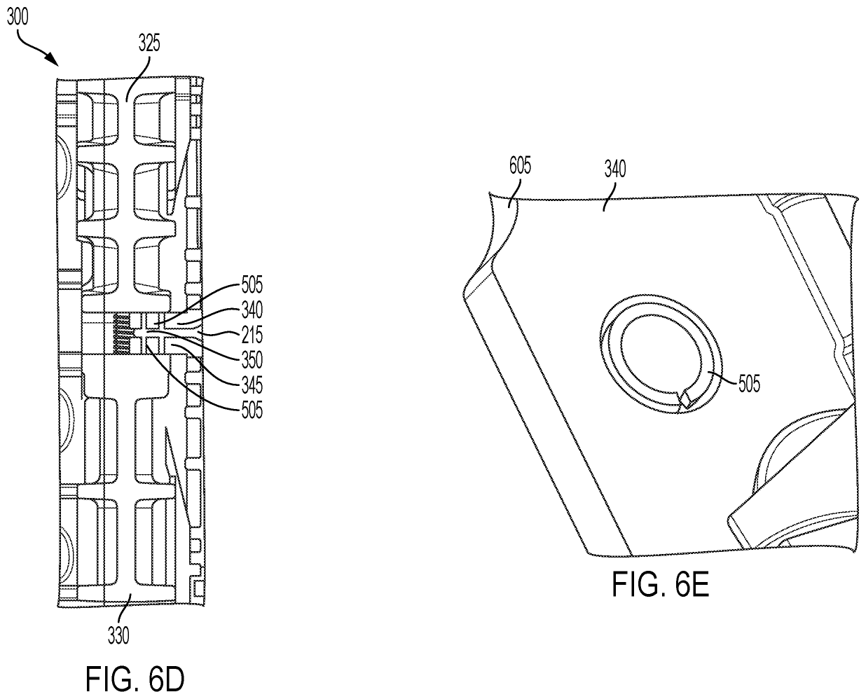

The system 300 can include various features to facilitate absorbing a compression load of the clamped joint to reduce fatigue, stress, strain, or creep at one or more portions of the joint. For example, FIGS. 5A, 5B, 6A, and 6B depict example front sectional views of the system 300 having at least one compression limiter 505 at the joint. FIG. 5C depicts a perspective view of one of the cross members (e.g., the second cross member 330) having a plurality of compression limiters 505 and FIG. 6C depicts a perspective view of one of the first carrier flanges 340 having a compression limiter 505. As depicted in at least FIGS. 5A-5C, the system 300 can include at least one compression limiter 505 coupled with at least one of the first cross member 325 or the second cross member 330 to support the fastener 335. For example, the compression limiter 505 can include a stiffer or stronger material than the first cross member 325 or second cross member 330 (e.g., a metallic material such as steel or aluminum) coupled with the first cross member 325 or the second cross member 330 to facilitate absorbing or distributing the load applied by the fastener 335 to clamp the joint. For example, the compression limiter 505 can include a strip of metallic material that surrounds a hole, opening, or aperture in the first cross member 325 or second cross member 330 that receives the fastener 335 such that, when the fastener 335 is tightened, the compression limiter 505 at least partially contacts one of the first carrier flanges 340 or the second carrier flanges 345. The system 300 can include at least two compression limiters 505 such that a first compression limiter 505 couples with the first cross member 325 and contacts at least one of the first carrier flanges 340 and a second compression limiter 505 that couples with the second cross member 330 and contacts at least one of the second carrier flanges 345. The compression limiter 505 can include a boss (e.g., protrusion) that extends from one or more of the first cross member 325 or the second cross member 330 to facilitate maintaining a clamp load of the joint over time, as depicted in FIG. 5A. In each of the first cross member 325 and the second cross member 330, each hole that receives a fastener 335 can include a compression limiter 505.

As depicted in at least FIGS. 6A-6E, the compression limiter 505 can be over-molded or insert molded on one or more of the first carrier flanges 340 or the second carrier flanges 345. For example, at least a portion of the first carrier flanges 340 or the second carrier flanges 345 can include one or more plastic materials and the compression limiter 505 can be molded to the plastic material to support the fastener 335. For example, as depicted in FIG. 6C, one or more of the first carrier flanges 340 or the second carrier flanges 345 can include a divot in the flange (e.g., substantially in a semi-circular shape) to at least partially receive a portion of the fastener 335 (e.g., about half a diameter of the fastener body). The divot of the flange can be over-molded with one or more metallic materials to form the compression limiter 505. The compression limiter 505 can facilitate distributing the load and maintaining clamp load of the joint over time.

As depicted in at least FIGS. 6D and 6E, the compression limiter 505 can couple with one of the first flange 340, the second flange 345, or a portion of the thermal component 215 at a position that is away from a through hole that receives a fastener 335. For example, the compression limiter 505 can couple with a hole, divot, or other opening that may or may not receive a fastener 335 (e.g., to support the clamp load applied by the first cross member 325 and second cross member 330 or the fastener 335 at a location positioned away from the fastener 335). The compression limiter 505 can couple directly with a portion of the thermal component 215. For example, the compression limiter 505 can couple with a portion of a thermal component flange 350 of the thermal component 215.

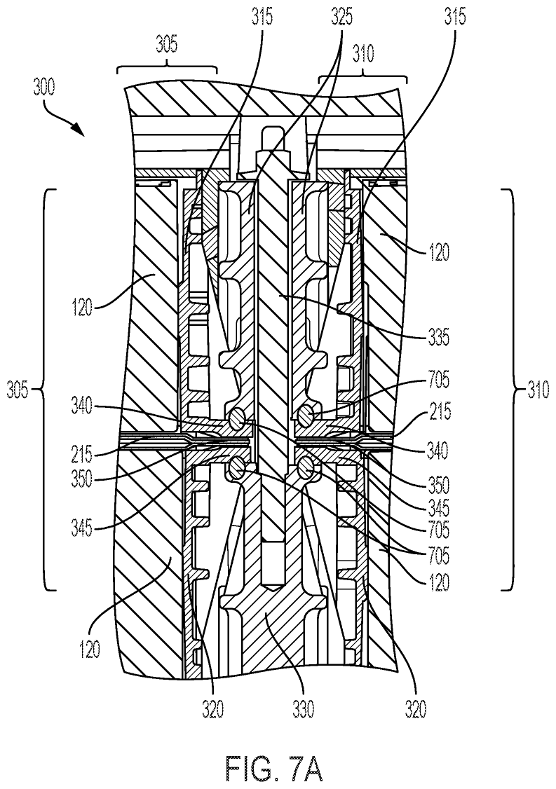

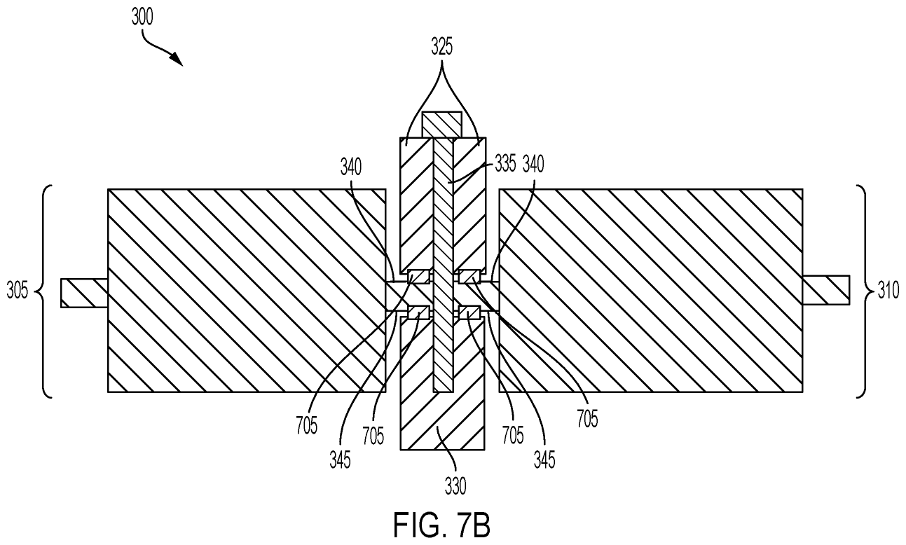

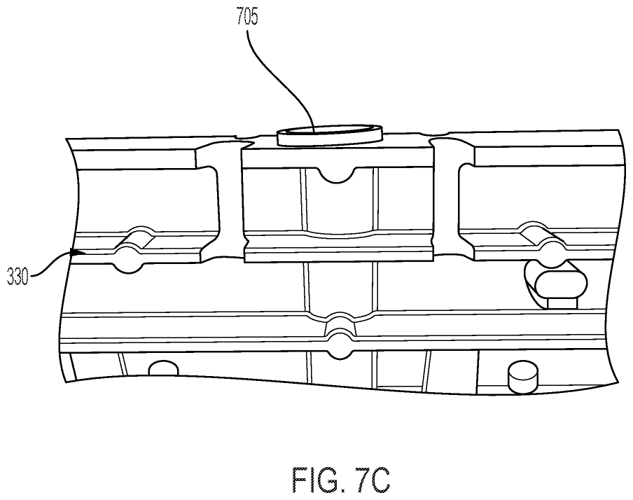

The system 300 can include at least one elastomer to facilitate absorbing a compression load of the joint or more evenly distributing a compression load across a flange 340. For example, FIGS. 7A and 7B depict example front sectional views of the system 300 having an elastomeric material 705 (a gasket, O-ring, or other seal made of ethylene propylene diene monomer (EPDM) or a stiff elastomer) at the joint. For example, the elastomeric material 705 can be or include a high-strength weather-resistant EPDM rubber sheet. The elastomeric material 705 can couple with one or more of the first flange 340, the second flange 345, the first cross member 325, or the second cross member 330. For example, one of the first flange 340, the second flange 345, the first cross member 325, or the second cross member 330 can include a groove to receive a portion of the elastomeric material 705. For example, FIG. 7C depicts a side view of a portion of the second cross member 330. The second cross member 330 can include an elastomeric material 705 (e.g., an O-ring or other elastic component) coupled with a portion of the second cross member 330. The elastomeric material 705 can have a ring shape including an opening to receive a portion of the fastener 335. The elastomeric material 705 can at least partially surround the fastener 335 such that the elastomeric material 705 engages with the second cross member 330 and the second flange 345 when the fastener 335 clamps the subassembly with the second cross member 330. The first cross member 325 can include an elastomeric material 705 that at least partially surrounds the fastener 335 such that the elastomeric material 705 engages with the first cross member 325 and the first flange 340 when the fastener 335 clamps the subassembly with the first cross member 325.

The elastomeric material 705 can include a gasket or seal that extends an entire width of the joint. For example, the elastomeric material 705 can extend along an entire width or width of the first cross member 325, the second cross member 330, or the first or second flanges 340, 345 at a surface in which the first cross member 325 engages the first flange 340 or a surface where the second cross member 330 engages the second flange 345. The full width gasket of elastomeric material 705 can couple with the first cross member 325, the second cross member 330, or one or both of the first or second flanges 340, 345 to facilitate sealing the joint along the full width of the joint. The system 300 can include at least one adhesive applied to at least a portion of the first flange 340, the second flange 345, the thermal component flange 350, the first cross member 325, or the second cross member 330 to fix the first flange 340 or second flange 345 relative to the first cross member 325 and the second cross member 330.

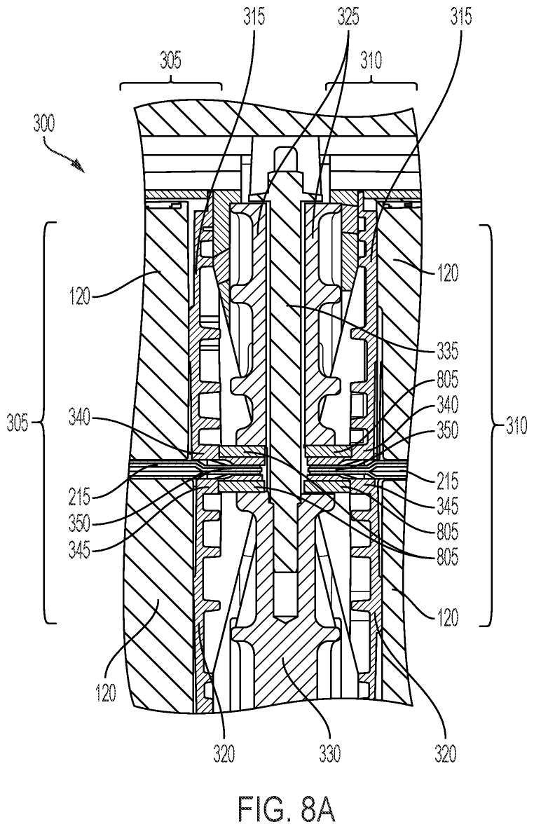

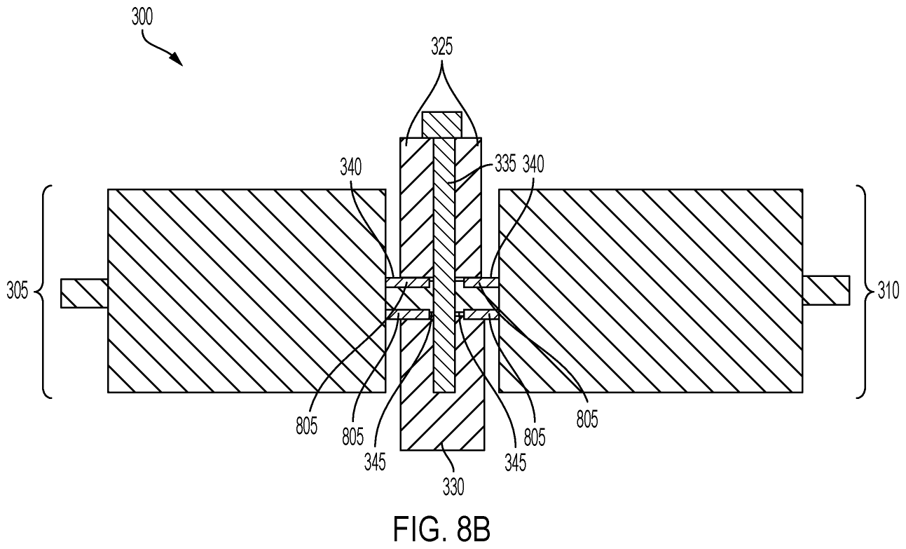

The system 300 can include at least one bracket to facilitate absorbing a compression load of the joint. For example, FIGS. 8A and 8B depict example front sectional views of the system 300 having at least one bracket 805 coupled to the first flange 340 or the second flange 345 at the joint. For example, the bracket 805 can be molded (e.g., over-molded or insert molded) onto a portion of the first flange 340 or the second flange 345. The bracket 805 can be made from various materials including, but not limited to, steel or aluminum. The bracket 805 can facilitate absorbing a compressive load from the first cross member 325 or the second cross member 330 when the fastener 335 clamps the one or more battery subassemblies between the first cross member 325 and the second cross member 330 (e.g., when the fastener is torqued). For example, the bracket 805 can engage with the first cross member 325 or the second cross member 330 to facilitate distributing the load throughout the first flange 340 or the second flange 345 to maintain a clamp load of the joint formed by the fastener 335 over time.

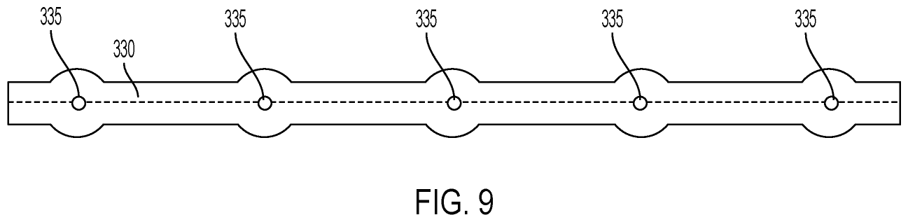

FIG. 9 depicts a top-down view of the second cross member 330. As depicted in at least FIG. 9, the second cross member 330 (and corresponding first cross member 325) can include a plurality of openings to receive one or more fasteners 335. As described herein, the system 300 can include an adhesive or a gasket that extends along the top surface of the second cross member 330 in a direction from left to right in FIG. 9 (e.g., along at least a portion or an entire length of the second cross member 330.

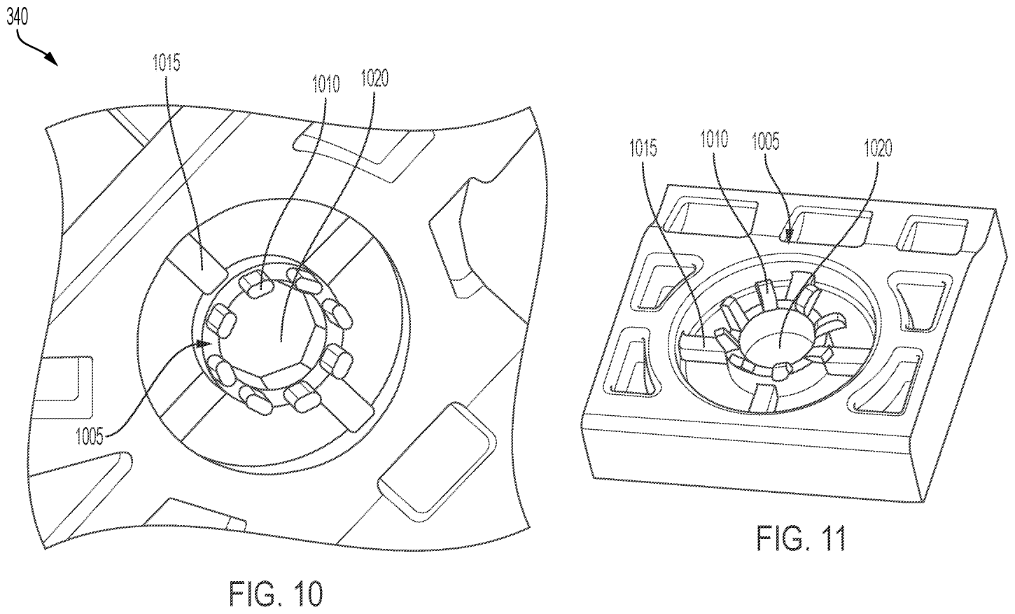

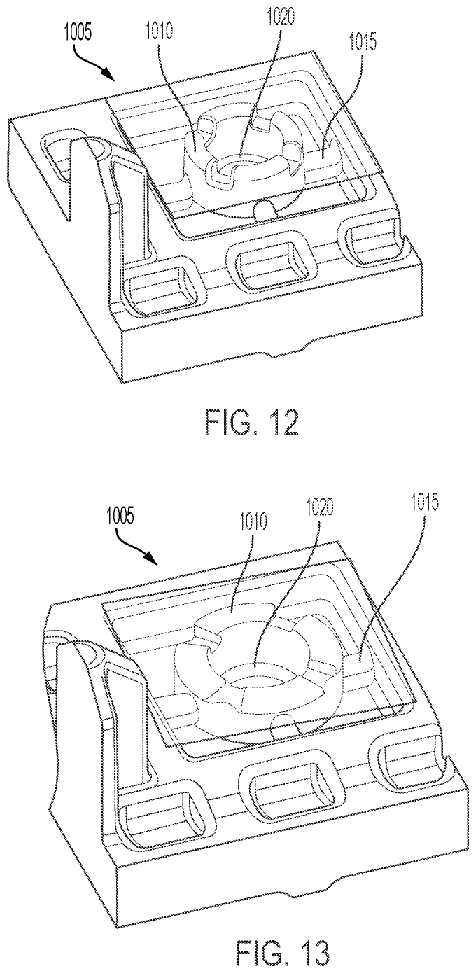

FIGS. 10 and 12 depict bottom views of a portion of the first flange 340. The first flange 340, or the second flange 345, can include at least one deformable protrusion 1005. The deformable protrusion 1005 can include, for example, one or more teeth 1010 that extend from a surface of the first flange 340 in a direction towards the second flange 345 and the thermal component 215. For example, the teeth 1010 can extend circumferentially around a center 1020 of the deformable protrusion 1005. The deformable protrusion 1005 can include at least one rib 1015 that extends outward along the flange 340 from the teeth 1010 to add strength to the teeth 1010. At least one of the teeth 1010 can deform responsive to contacting or engaging with one or more of the first cross member 325, the second cross member 330, the thermal component 215 (e.g., the thermal component flange 350), or the second flange 345. For example, the teeth 1010 can deform to facilitate absorbing a load applied by the first or second subassemblies 305, 310 to the first cross member 325, the second cross member 330, the thermal component 215 (e.g., the thermal component flange 350), or the second flange 345 when these components are clamped together by the fastener 335. For example, FIGS. 11 and 13 depict the deformable protrusion 1005 in a deformed state when the teeth 1010 contact a portion of the joint, such as the thermal component flange 350. As depicted in at least FIGS. 10-13, the deformable protrusion 1005 can include any amount of teeth 1010 (e.g., four teeth 1010, eight teeth 1010, or more or less teeth 1010) of one or more sizes.

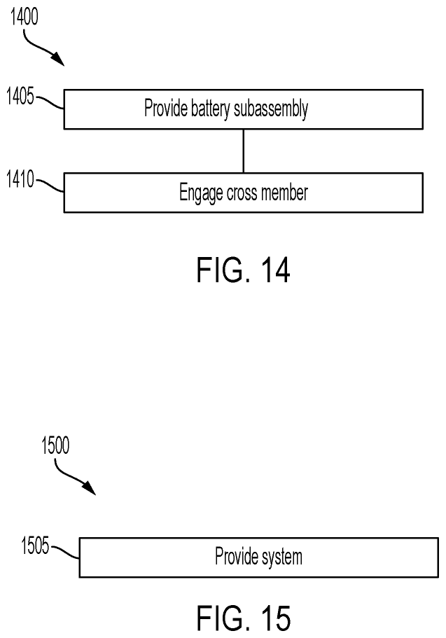

FIG. 14 depicts an example method 1400. The method 1400 can include providing a battery subassembly, as depicted in act 1405. For example, the battery subassembly can be or include the first battery subassembly 305 or the second battery subassembly 310. The first battery subassembly 305 (or the second battery subassembly 310) can include various components to facilitate storing at least one battery cell 120 within a vehicle 105. For example, the first battery subassembly 305 can include a first cell carrier 315, a second cell carrier 320, or a thermal component 215. The first cell carrier 315 can include one or more components to hold or carry at least one battery cell 120 in position. The second cell carrier 320 can include a similar configuration and size as the first cell carrier 315. The thermal component 215 can be positioned at a middle portion of the first battery submodule 305 between the first cell carrier 315 and the second cell carrier 320.

The first cell carrier 315 (e.g., of the first battery subassembly 305 or the second battery subassembly 310) can include a first carrier flange 340 and the second cell carrier 320 (e.g., of the first battery subassembly 305 or the second battery subassembly 310) can include a second carrier flange 345. Each of the first carrier flange 340 and the second carrier flange 345 can extend or protrude substantially sideways from the respective cell carriers (e.g., such that the first carrier flange 340 defines the outermost portion of the first cell carrier 315 and the second carrier flange 345 defines the outermost portion of the second cell carrier 320). The thermal component 215 (e.g., of first battery subassembly 305 or the second battery subassembly 310) can include a thermal component flange 350. The thermal component flange 350 can be disposed between and in at least partial contact with the first carrier flange 340 and the second carrier flange 345. The thermal component flange 350 can extend or protrude substantially sideways from the thermal component 215 (e.g., such that the thermal component flange 350 defines the outermost portion of the thermal component 215).

The method 1400 can include engaging the first cross member 325 or the second cross member 330 of the battery pack 110, as depicted in act 1410. For example, a flange (e.g., the first flange 340, the second flange 345, or the thermal component flange 350) can engage the first cross member 325 and the second cross member 330 using the fastener 335 to clamp the battery subassembly 305 with the first cross member 325 and the second cross member 330. For example, each of the first carrier flange 340, the thermal component flange 350, and the second carrier flange 345 can be stacked together in an outwardly protruding manner such that the first cross member 325 and the second cross member 330 can clamp the first carrier flange 340, the thermal component flange 350, and the second carrier flange 345 together by the fastener 335 to fix the first subassembly 305 or the second subassembly 310 together or with the vehicle 105. For example, one or more of the first flange 340, the second flange 345, or the thermal component flange 350 can engage with the first cross member 325 and the second cross member 330 using the fastener 335 to clamp the first battery subassembly 305 with the first cross member 325 and the second cross member 330. For example, the fastener 335 at least partially extending through the first cross member 325 (e.g., through an opening in the first cross member 325), the first carrier flanges 340 (e.g., through a divot in the flange 340), the thermal component flanges 350 (e.g., through a divot in the flange 350), the second carrier flanges 345 (e.g., through a divot in the flange 345), or the second cross member 330 (e.g., through an opening in the second cross member 330) can form a clamped joint to fix the first battery subassembly 305 or the second battery subassembly 310 in place relative to the battery pack 110 or the vehicle 105.

FIG. 15 depicts an example method 1500. The method 1500 can include providing a system 300, as depicted in act 1505. The system 300 can include at least one battery subassembly 305, 310 having a flange (e.g., the first flange 340 or the second flange 345) that can engage (e.g., at least partially contact, couple together, etc.) the first cross member 325 and the second cross member 330 by the fastener 335 to clamp the battery subassembly with the first cross member 325 and the second cross member 330 (e.g., to form a clamped joint to fix the one or more battery subassemblies 305, 310 with the battery pack 110 or the vehicle 105).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, the joint can include more or less fasteners than shown in the figures. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
a battery subassembly comprising a flange; and
the flange configured to engage a first cross member and a second cross member of a battery pack using a fastener to clamp the battery subassembly with the first cross member and with the second cross member.

2. The system of claim 1, comprising:
the battery subassembly comprising a second flange and a thermal component disposed at least partially between the flange and the second flange;
the fastener to at least partially clamp the first cross member and the second cross member; and
the first cross member and the second cross member to apply a clamp load to the flange and the second flange.

3. The system of claim 1, comprising:
the fastener to clamp at least a portion of a second battery subassembly between the first cross member and the second cross member to couple the battery subassembly and the second battery subassembly with the battery pack.

4. The system of claim 1, comprising:
a compression limiter coupled with the flange to support the fastener.

5. The system of claim 1, comprising:
a compression limiter coupled with at least one of the first cross member or the second cross member; and
the compression limiter to support the fastener.

6. The system of claim 1, comprising:
an elastomeric component coupled with the first cross member; and
the elastomeric component configured to engage with the flange.

7. The system of claim 1, comprising:
a bracket coupled with the flange; and
the bracket configured to engage with one of the first cross member or the second cross member.

8. The system of claim 1, comprising:
the flange comprising a protrusion configured to deform responsive to the fastener clamping the flange between the first cross member and the second cross member.

9. The system of claim 1, comprising:
an adhesive applied to at least a portion of at least one of the flange, the first cross member, or the second cross member to fix the flange relative to the first cross member and the second cross member.

10. The system of claim 1, comprising:
the fastener configured to at least partially extend through the flange, the first cross member, and the second cross member to clamp the battery subassembly with the first cross member and the second cross member.

11. An electric vehicle, comprising:
a battery subassembly comprising a flange; and
the flange configured to engage a first cross member and a second cross member of a battery pack using a fastener to clamp the battery subassembly with the first cross member and with the second cross member.

12. The electric vehicle of claim 11, comprising:
the battery subassembly comprising a second flange and a thermal component disposed at least partially between the flange and the second flange;
the fastener to at least partially clamp the first cross member and the second cross member; and
the first cross member and the second cross member to apply a clamp load to the flange and the second flange.

13. The electric vehicle of claim 11, comprising:
the fastener to clamp at least a portion of a second battery subassembly between the first cross member and the second cross member to couple the battery subassembly and the second battery subassembly with the battery pack.

14. The electric vehicle of claim 11, comprising:
a compression limiter coupled with the flange to support the fastener.

15. The electric vehicle of claim 11, comprising:
a compression limiter coupled with at least one of the first cross member or the second cross member; and
the compression limiter to support the fastener.

16. The electric vehicle of claim 11, comprising:
an elastomeric component coupled with the first cross member; and
the elastomeric component configured to engage with the flange.

17. The electric vehicle of claim 11, comprising:
a bracket coupled with the flange; and
the bracket configured to engage with one of the first cross member or the second cross member.

18. The electric vehicle of claim 11, comprising:
the flange comprising a protrusion configured to deform responsive to the fastener clamping the flange between the first cross member and the second cross member.

19. A method, comprising:
providing a battery subassembly comprising a flange; and
engaging, by the flange, a first cross member and a second cross member of a battery pack using a fastener to clamp the battery subassembly with the first cross member and the second cross member.

20. The method of claim 19, comprising:
the battery subassembly comprising a second flange and a thermal component disposed at least partially between the flange and the second flange;
at least partially clamping, by the fastener, the first cross member and the second cross member; and
applying, by the first cross member and the second cross member, a clamp load to the flange and the second flange.
